(19) United States
(12) Patent Application Publication
(10) Pub. No.: US 2002/0014346 A1
(43) Pub. Date: Feb. 7, 2002

(54) Mounting structure of semiconductor package

(75) Inventors: Kimio Tsunemasu, Tokyo (JP); Yasunori Tanaka, Tokyo (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 09/872,256

(22) Filed: Jun. 1, 2001

(30) Foreign Application Priority Data
Jun. 14, 2000 (JP) 2000-178824

(51) Int. Cl. H02G 3/08

(52) U.S. Cl. 174/52.1; 174/52.2

(57) ABSTRACT

A mounting structure of a semiconductor package can improve resistance against thermal and mechanical external force. The mounting structure of a semiconductor package establishes electrical connection of a pad on a printing circuit board to a connection wiring by soldering the semiconductor package. The pad may be integrally formed with a via. The soldering may be performed by penetrating a part of solder within the via so that the connection wiring is connected to the pad through the via at a layer different from a layer of the pad.

### BACKGROUND OF THE INVENTION

1. Field of the Invention

The present invention relates to a mounting structure of a semiconductor package for electrical connection with a connection wiring by soldering the semiconductor package on a pad on a printed circuit board.

2. Description of the Related Art

Recently, as a semiconductor package to be mounted in a mobile terminal, a CPS type semiconductor package has been developed. The CPS type semiconductor package is called as Chip Scale Package.

Conventionally, since the CSP type semiconductor package is mounted by soldering on a printed circuit board, an annular pad 2 is formed on the surface layer of the printed circuit board 1 as shown in FIGS. 4 and 5. A head portion 3a of the connection wiring 3 is integrated by burying within the annular pad 2. The pad and the connection wiring 3 lead therefrom are provided on the same layer, namely on the surface of the printed circuit board 1.

On the other hand, in order to enhance wettability of the semiconductor package with the solder 5, a plating 6 is provided over the pad 2 and the head portion 3a of the connection wiring 3. Also, for mutual insulation between adjacent pad 2 and the connection wiring 3, a solder resist 7 is applied on the surface layer of the printed circuit board 1. As shown in FIGS. 4 and 5, the solder resist 7 contacts with the plating 6 at the outer circumference of the pad 2 and the connection wiring 3 is covered by the solder resist 7. The reference numeral 10 denotes a runout for the solder resist provided between the pad 2 and the solder resist 7.

When the CSP type semiconductor package is mounted and soldered on the printed circuit board 1, electrical connection with the semiconductor package is established on the plating 6 provided on the head portion 3a of the connection wiring 3, as shown in FIG. 5.

In general, a copper wire is used as the connection wiring 3, and nickel plating is used as plating. As shown in FIG. 6, by heating of the semiconductor package, expansion and contraction is caused in the copper wire 3, the nickel plating 6 and the solder resist.

As in the prior art, when wiring of the connection wiring 3 on the surface layer of the printed circuit board 1, since respective expansion coefficients are different and expanding directions are mutually opposite directions. When thermal and mechanical external force is applied, on the copper wiring 3, on which both of nickel plating 6 and solder resist 7 are applied, a stress F can be developed at the portion of the nickel plating 6 and the solder resist.

By development of the stress F, breakage of copper wire 3 is caused at the boundary portion of the nickel plating 6 and the solder resist 7. By breakage of the copper wiring 3, the semiconductor device can be broken.

### SUMMARY OF THE INVENTION

It is an object of the present invention to provide a mounting structure of a semiconductor package which can improve resistance against thermal and mechanical external force.

According to one aspect of the present invention, a mounting structure of a semiconductor package for establishing electrical connection of a pad on a printing circuit board to a connection wiring by soldering the semiconductor package, comprises:

the pad being integrally formed with a via;

the soldering being performed by penetrating a part of solder within the via so that the connection wiring is connected to the pad through the via at a layer different from a layer of the pad.

In the preferred construction, the via may be depressed from the pad of annular shape on the printed circuit board to project for establishing electrical connection with the connection wiring at the tip end thereof.

A plating may be provided on the surface of the pad and an inner surface of the via.

The via may be formed in the pad of the printed circuit board corresponding to a corner of the semiconductor package.

The via may be projected from the pad in truncated cone shape to extend into a through hole of the printed circuit board and is integrally connected with the connection wiring.

A vacant space may be certainly provided between an outer circumference of the pad and a solder resist on the printed circuit board.

### BRIEF DESCRIPTION OF THE DRAWINGS

The present invention will be understood more fully from the detailed description given hereinafter and from the accompanying drawings of the preferred embodiment of the present invention, which, however, should not be taken to be limitative to the invention, but are for explanation and understanding only.

In the drawings:

FIG. 1 is a fragmentary illustration showing a mounting structure of a semiconductor package in accordance with the present invention;

FIG. 2 is a plan view showing a construction in the major part of the mounting structure in the printing circuit board;

FIG. 3 is a section taken along line A-A of FIG. 2;

FIG. 4 is a plan view showing a construction on the printed circuit board with respect to the major part of the conventional mounting structure of the semiconductor package;

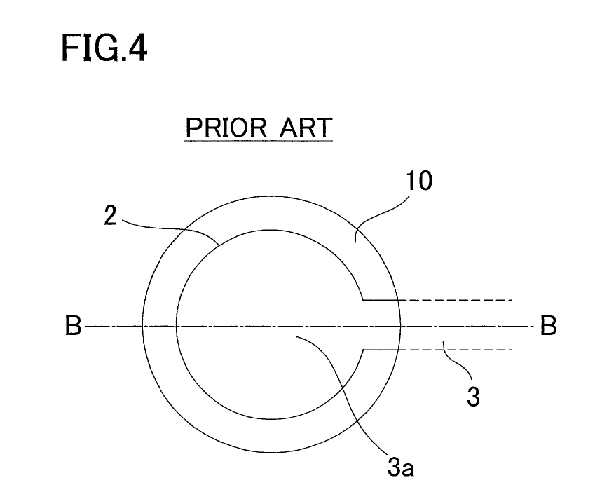

FIG. 5 is a section taken along line B-B of FIG. 4; and

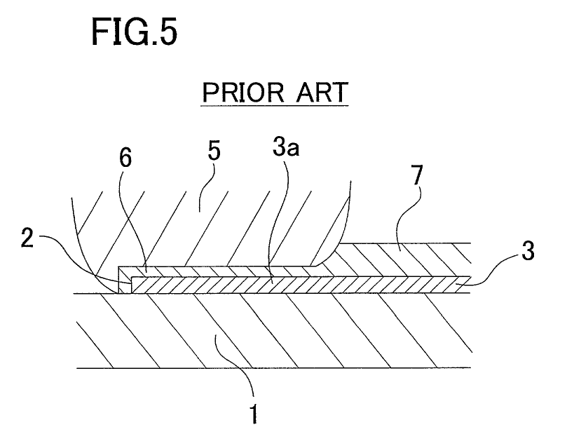

FIG. 6 is a section for explaining problem in the prior art.

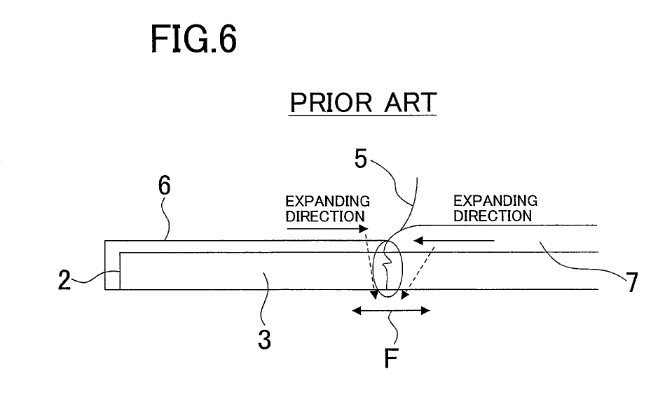

### DESCRIPTION OF THE PREFERRED EMBODIMENT

The present invention will be discussed hereinafter in detail in terms of the preferred embodiment of the present invention with reference to the accompanying drawings. In the following description, numerous specific details are set forth in order to provide a thorough understanding of the present invention. It will be obvious, however, to those skilled in the art that the present invention may be practiced without these specific details. In other instance, well-known structure are not shown in detail in order to avoid unnecessary obscurity of the present invention.

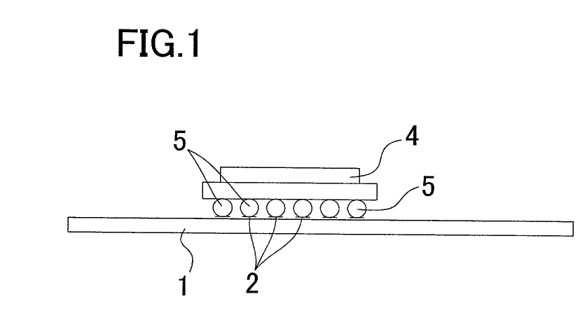

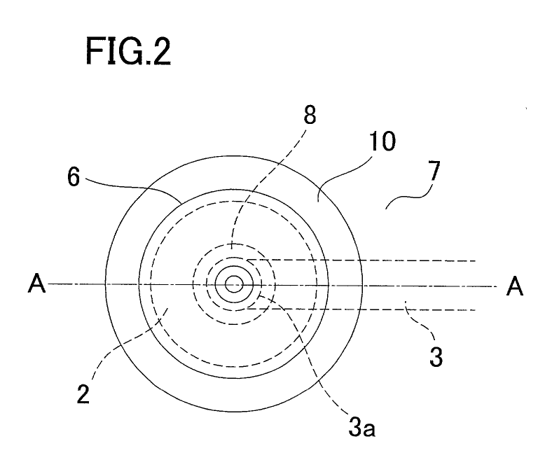

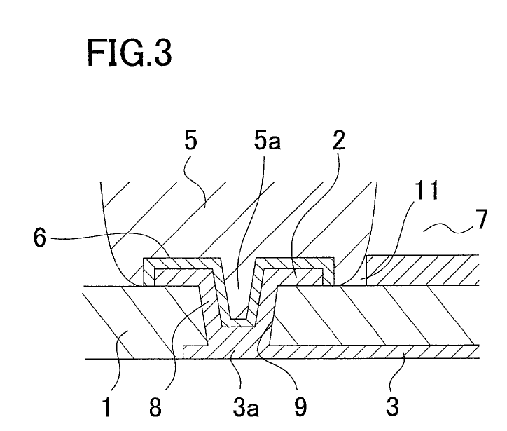

FIG. 1 is a fragmentary illustration showing a mounting structure of a semiconductor package in accordance with the present invention, FIG. 2 is a plan view showing a construction in the major part of the mounting structure in the printing circuit board, and FIG. 3 is a section taken along line A-A of FIG. 2.

As shown in FIGS. 1 and 2, in a mounting structure of a semiconductor package according to the present invention, a semiconductor package 4 is mounted on a pad 2 formed on a printed circuit board 1 by soldering using a solder 5, such as solder ball or the like.

As shown in FIGS. 2 and 3, a via 8 is formed integrally with the pad 2 of the printed circuit board 1 projecting therefrom. The pad 2 and the connection wiring 3 are connected through the via 8. By this, the pad 2 and the connection wiring 3 are provided at different level across the printed circuit board 1.

In the example shown in FIGS. 2 and 3, the pad 2 and the solder resist 7 are provided on the surface of the printed circuit board 1, the via 8 is provided within a through opening 9 of the printed circuit board 1 and the connection wiring 3 is provided on back surface of the printed circuit board 1.

The pad 2 is formed into annular shape on the surface of the printed circuit board 1. Between the outer circumference of the pad 2 and a solder resist 7, a run out 10 for the solder resist is certainly provided. The via 8 is depressed from the pad 2 to integrally project downwardly therefrom in truncated cone shape via the through hole 9. Then, a tip end portion of the via 8 is connected integrally with the head portion 3a of the connection wiring 3 printed on the back surface of the printed circuit board 1.

On the entire surface of the annular pad 2 and inner surface of the depressed via 8, a plating 6 is provided continuously.

Upon mounting the semiconductor package 4 on the printing circuit board 1 of the construction set forth above, the solder 5 deposited on an electrode surface of the semiconductor package 4 is positioned relative to the pad 2 on the printed circuit board 1, as shown in FIG. 1. A solder paste is supplied and the solder 5 is molten to solder the electrode of the semiconductor package 4 to the pad 2 of the printed circuit board 1 by reflow soldering. The molten solder 5 is cured in a condition where a part 5a of the molten solder penetrates into the via 8 which is integral with the pad 2.

By connecting the solder 5 with the pad 2 by burying the part 5a within the via 8, degree of connection of the semiconductor package 4 to the printed circuit board 1 can be enhanced to firmly mounted the semiconductor package 4 to the printed circuit board 1.

Also, since runout 10 for the solder resist is certainly provided around the annular pad 2, a vacant space 11 can be certainly maintained between the solver resist 7 even when solder 5 is provided on the plating 6 on the surface of the pad 2.

It should be noted that, upon formation of the via 8 in the pad 2, it is not necessary to form the via for all of the pads. For instance, the via 8 may be formed only for the pad 2 on the printed circuit board 1 corresponding to the solder 5 deposited at the corner portion of the semiconductor package 4.

On the other hand, as shown in FIG. 3, the via 8 is formed through the printed circuit board 1. When the printed circuit board 1 has a multilayer board structure, the via is not necessarily extended across all of the layers. When the connection wiring 3 is provided in the layer different from the surface layer of the printed circuit board 1, the via 8 capable of connection between the connection wiring 3 and pad 2 is only required.

On the other hand, while the present invention has been discussed for application for the pad 2 of the printed circuit board 1 corresponding to the CSP type semiconductor package, the invention is also applicable fort he package other than the CSP type semiconductor package.

As set forth above, with the present invention, since the layer connecting the semiconductor package to the pad and the connection wiring are arranged at different layer relative to the printing circuit board, it can avoid direct application of the stress to the connection wiring due to thermal expansion of the plating or the solder resist. The characteristics of the semiconductor device can be maintained for a long period.

Furthermore, since the solder can be cured in the condition where the solder is buried in the via which is integral with the pad, connection area between the solder and the pad can be increased to increase strength of soldering.

In addition, by providing the connection wiring on the layer different from the pad and distant from the solder resist, a vacant space can be certainly provide so that the vacant space may also serve for elimination of stress to be exerted on the connection wiring.

Although the present invention has been illustrated and described with respect to exemplary embodiment thereof, it should be understood by those skilled in the art that the foregoing and various other changes, omission and additions may be made therein and thereto, without departing from the spirit and scope of the present invention. Therefore, the present invention should not be understood as limited to the specific embodiment set out above but to include all possible embodiments which can be embodied within a scope encompassed and equivalent thereof with respect to the feature set out in the appended claims.

What is claimed is:

1. A mounting structure of a semiconductor package for establishing electrical connection of a pad on a printing circuit board to a connection wiring by soldering the semiconductor package, comprising:
said pad being integrally formed with a via;
said soldering being performed by penetrating a part of solder within said via so that said connection wiring is connected to said pad through said via at a layer different from a layer of said pad.

2. A mounting structure of a semiconductor package as set forth in claim 1, wherein said via is depressed from said pad of annular shape on said printed circuit board to project for establishing electrical connection with the connection wiring at the tip end thereof.

3. A mounting structure of a semiconductor package as set forth in claim 1 or 2, wherein a plating is provided on the surface of said pad and an inner surface of said via.

4. A mounting structure of a semiconductor package as set forth in claim 1, wherein said via is formed in said pad of said printed circuit board corresponding to a corner of said semiconductor package.

5. A mounting structure of a semiconductor package as set forth in claim 1 or 2, wherein said via is projected from said pad in truncated cone shape to extend into a through hole of said printed circuit board and is integrally connected with said connection wiring.

6. A mounting structure of a semiconductor package as set forth in claim 3, wherein said via is projected from said pad in truncated cone shape to extend into a through hole of said printed circuit board and is integrally connected with said connection wiring.

7. A mounting structure of a semiconductor package as set forth in claim 2, wherein a vacant space is certainly provided between an outer circumference of said pad and a solder resist on said printed circuit board.
